(19) United States
(12) Patent Application Publication
(10) Pub. No.: US 2025/0274765 A1
(43) Pub. Date: Aug. 28, 2025

(54) METHODS, ARCHITECTURES, APPARATUSES AND SYSTEMS FOR ASSERTION OF WIRELESS TRANSMIT/RECEIVE UNIT (WTRU) TRUSTWORTHINESS

(71) Applicant: INTERDIGITAL PATENT HOLDINGS, INC., Wilmington, DE (US)

(72) Inventors: Alec Brusilovsky, Downingtown, PA (US); Michelle Perras, Montreal (CA); Samir Ferdi, Kirkland (CA); Zhibi Wang, Woodridge, IL (US)

(21) Appl. No.: 18/861,389

(22) PCT Filed: Apr. 27, 2023
(86) PCT No.: PCT/US2023/020136

§ 371 Date: Oct. 29, 2024

Related U.S. Application Data
(60) Provisional application No. 63/336,441, filed on Apr. 29, 2022.

(51) Int. Cl. H04W 12/60; H04W 12/043; H04W 12/06; H04W 12/10; H04W 76/10; H04W 92/18

(52) U.S. Cl. CPC H04W 12/66; H04W 12/043; H04W 12/06; H04W 12/10; H04W 76/10; H04W 92/18

(57) ABSTRACT

Procedures, methods, architectures, apparatuses, systems, devices, and computer program products directed to assertion of a relay WTRU trustworthiness In an embodiment, an apparatus may be configured to send, to a relay WTRU, a request message to obtain information indicating a trustworthiness of the relay WTRU to perform as a relay; to receive, from the relay WTRU, a response to the request message including information indicating a trustworthiness of the relay WTRU to perform as a relay; and to authenticate using a key identifier, the information indicating a trustworthiness of the relay WTRU.

### CROSS-REFERENCE TO RELATED APPLICATIONS

This application claims the benefit of U.S. Provisional Patent Application No. 63/336,441 filed Apr. 29, 2022, which is incorporated herein by reference.

### TECHNICAL FIELD

The present disclosure is generally directed to the fields of communications, software and encoding, including, for example, to methods, architectures, apparatuses, systems directed to the assertion of relay WTRU trustworthiness, for example to methods, apparatus and systems using proximity-based services (ProSe) and other WTRU to network relay applications.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of 5G ProSe direct discovery with a first model A;

FIG. 3 depicts an example of 5G ProSe direct discovery with a second model B;

FIG. 4 illustrates an example of an architecture model using a ProSe WTRU-to-Network Relay;

FIG. 5 illustrates an example of a passport model;

FIG. 6 illustrates an example of a background-check model;

FIG. 7 illustrates an example of a relay discovery procedure with relay WTRU trustworthiness;

FIG. 8 illustrates an example of an assertion of trustworthiness of remote WTRU and relay using solicitation procedure;

FIG. 9 illustrates an example of an assertion of trustworthiness of remote WTRU and relay using Announcement procedure;

FIG. 10 illustrates an example of an assertion of trustworthiness of remote WTRU and relay during unicast (e.g., PC5) link establishment procedure;

FIG. 11 illustrates a procedure for relay connection establishment using network-assisted remote attestation;

FIG. 12 illustrates a procedure for relay connection establishment using ProSe key management function (PKMF) assisted remote attestation;

FIG. 13 illustrates a procedure for WTRU remote attestation during PDU session establishment;

FIG. 14 illustrates a procedure for WTRU remote attestation during registration. procedure;

FIG. 15 illustrates another example of a method for assertion of a relay WTRU trustworthiness; and

FIG. 16 illustrates another example of a method for assertion of a relay WTRU trustworthiness.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

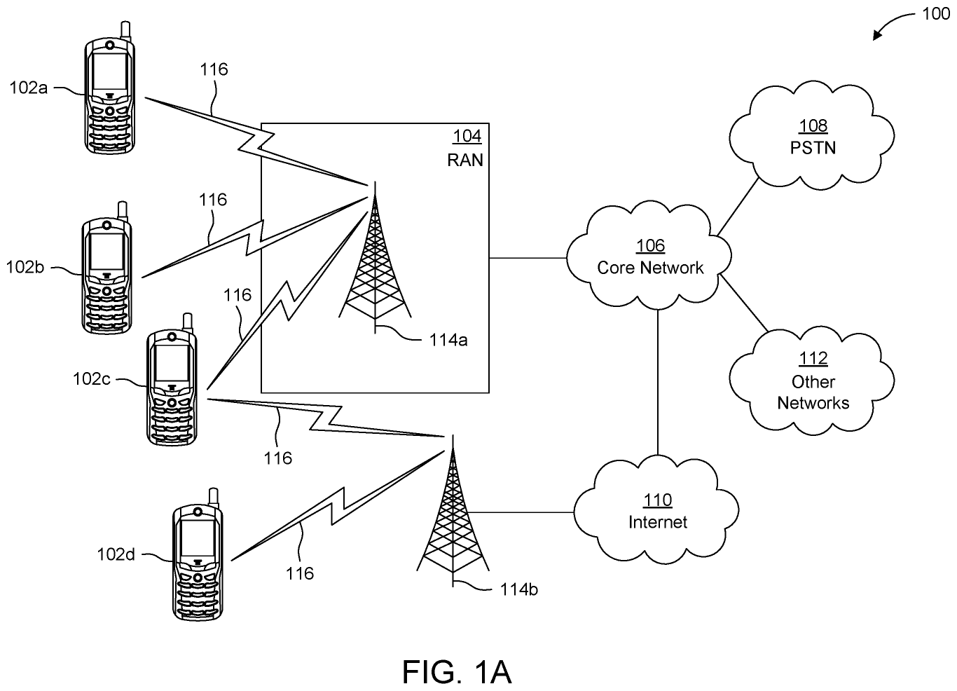

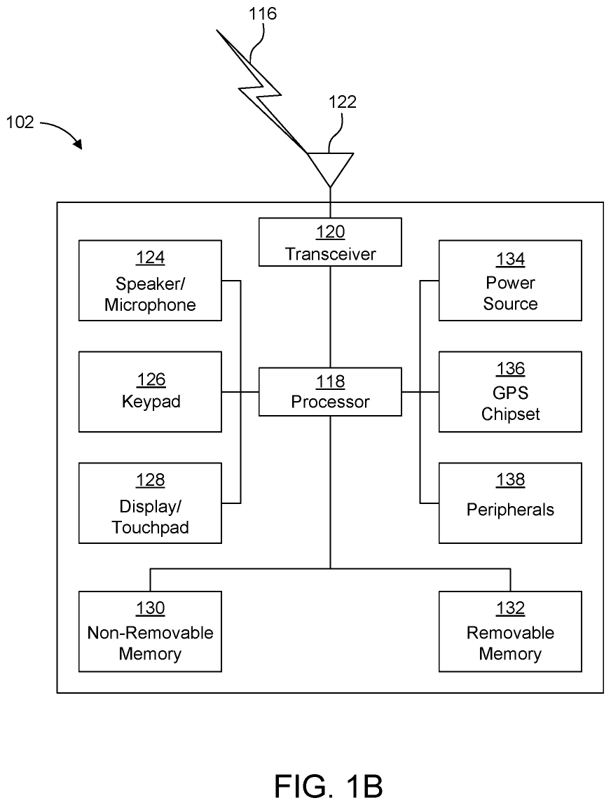

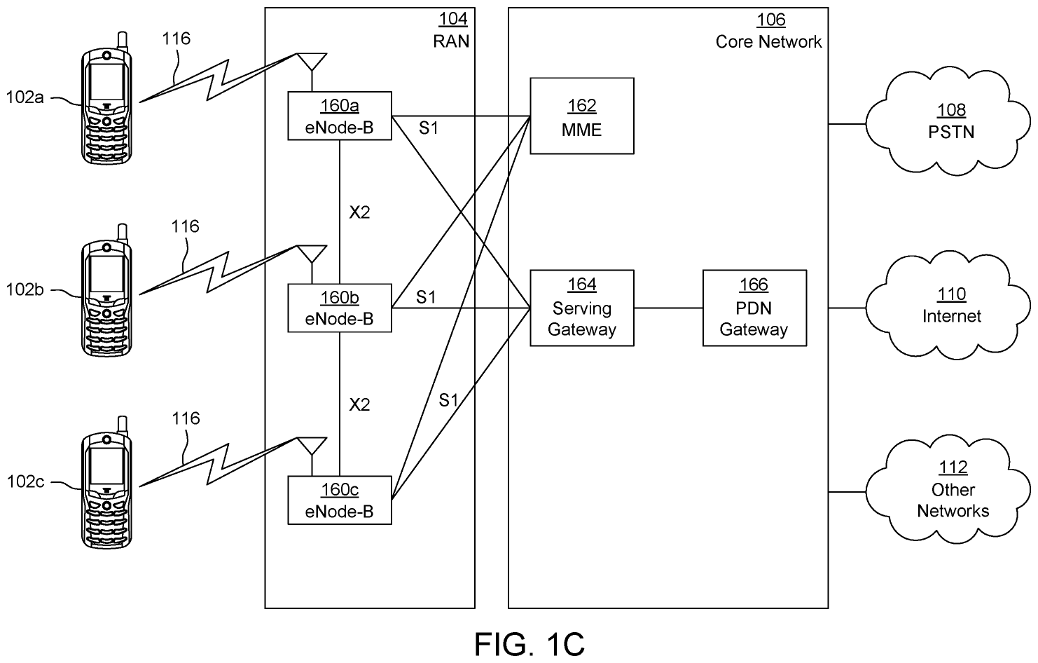

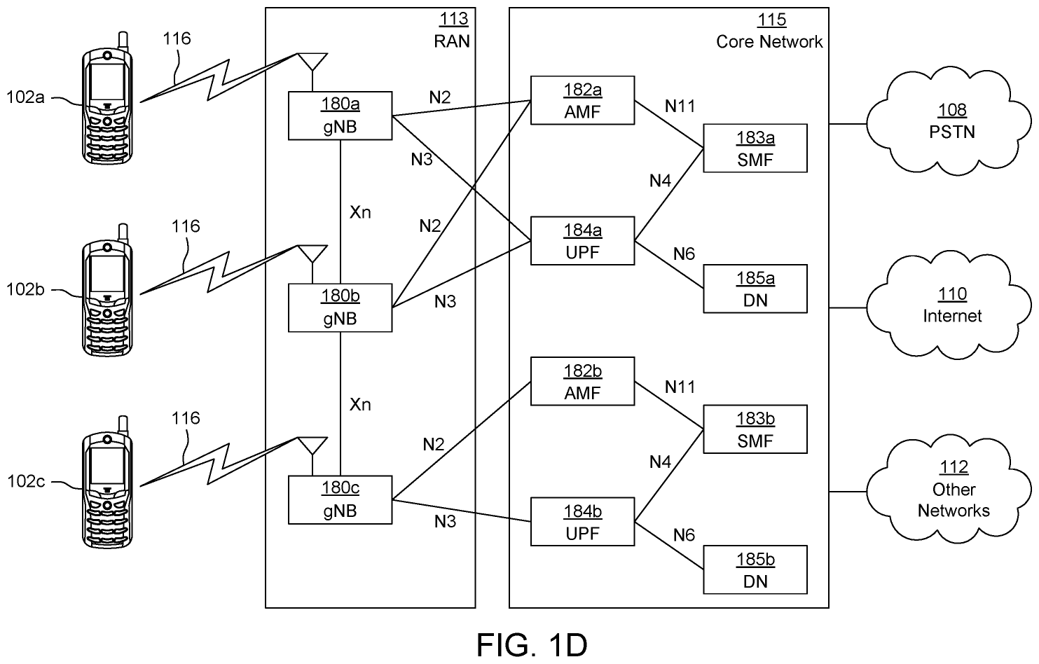

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA20001X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi- homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

According to an embodiment, a method of assertion of the relay WTRU trustworthiness performed by a remote WTRU is described, the method comprising any of the following actions:
The remote WTRU may obtain relay trustworthiness evidence token (information) from relay during discovery procedure, or during link establishment with the relay, or from an application function (AF) prior or after link establishment with the relay (AF connection info pre-configured or provided during connection via relay).
The remote WTRU may verify relay trustworthiness evidence token even while out of macro coverage.
The remote WTRU may use relay WTRU trustworthiness evidence token to make a decision about relay WTRU trustworthiness and proceeds with connection with the relay WTRU if it is deemed trusted or rejects the relay WTRU connection if the relay WTRU is deemed untrusted.

According to an embodiment, a method of assertion of the remote WTRU trustworthiness performed by a relay WTRU is described, the method comprising any of the following actions:
The relay WTRU may obtain remote WTRU trustworthiness evidence token (information) from the remote WTRU during discovery procedure, or during link establishment with the remote WTRU or from an AF prior or after link establishment with the remote WTRU (e.g., AF connection info is pre-configured).
The relay WTRU may verify remote WTRU trustworthiness evidence token via its available macro coverage or autonomously, even while out of macro coverage.
The relay WTRU may use remote WTRU trustworthiness evidence token to make a decision about remote WTRU trustworthiness and proceeds with connection with the Remote WTRU if it is deemed trusted or rejects the remote WTRU connection if the remote WTRU is deemed untrusted.

According to an embodiment, a method of Network Controlled assertion of Relay trustworthiness performed by a remote WTRU is described, the method comprising any of the following actions: A remote WTRU performing assessment of relay trustworthiness of relay WTRU during a network controlled authorization. The remote WTRU requests attestation result in a connection request with the relay WTRU. The remote WTRU may receive attestation result (e.g., in Direct Security Mode Complete (DSMC)) protected by network access key based on Remote WTRU primary authentication. Remote WTRU may verify result security and passes results to the upper layer before proceeding with link establishment.

According to an embodiment, a method of WTRU remote attestation during enhanced PDU Session establishment procedure is described, performed by a WTRU, the method comprising any of the following actions: the WTRU may perform a remote attestation procedure as part of PDU Session establishment enhanced with Remote attestation. Remote attestation may be performed via SMF over NAS. The relay WTRU may receive attestation evidence info in PDU establishment accept the message and present this to other WTRUs/network entities (e.g., Remote WTRU(s) that wishes to connect with WTRU acting as a relay).

According to an embodiment, a method of WTRU remote attestation during the enhanced Registration procedure performed by a WTRU is described, the method comprising any of the following actions: the WTRU may perform a remote attestation procedure as part of the Registration procedure enhanced with Remote attestation. Remote attestation may be performed via AMF over NAS. WTRU may receive attestation evidence during a WTRU/UE configuration update (UCU) procedure and presents it to other WTRUs/network entities (e.g., to a Remote WTRU(s) that wishes to connect when acting as a relay).

### Proximity-Based Services (ProSe)

Proximity Services (ProSe) are services that can be provided by the 3GPP system based on WTRUs being in proximity to each other. To provide Proximity Services, WTRUs may perform a ProSe discovery procedure to discover other WTRUs in proximity.

There may be two ProSe discovery modes: Model A and Model B.

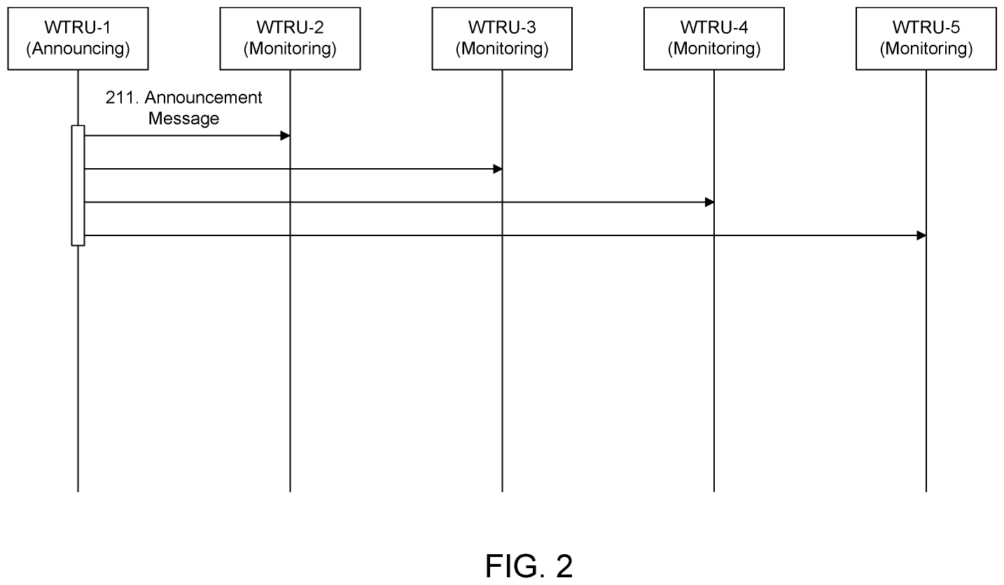

In model A, as illustrated in FIG. 2, a WTRU (e.g., announcing WTRU) may broadcast an announcement message (211), for example, with ProSe code (which may be associated with announcing WTRU's ID or associated with to service provided by the announcing WTRU). Other WTRUs who received the announcement message (Monitoring WTRU) may know the announcing WTRU may be in proximity.

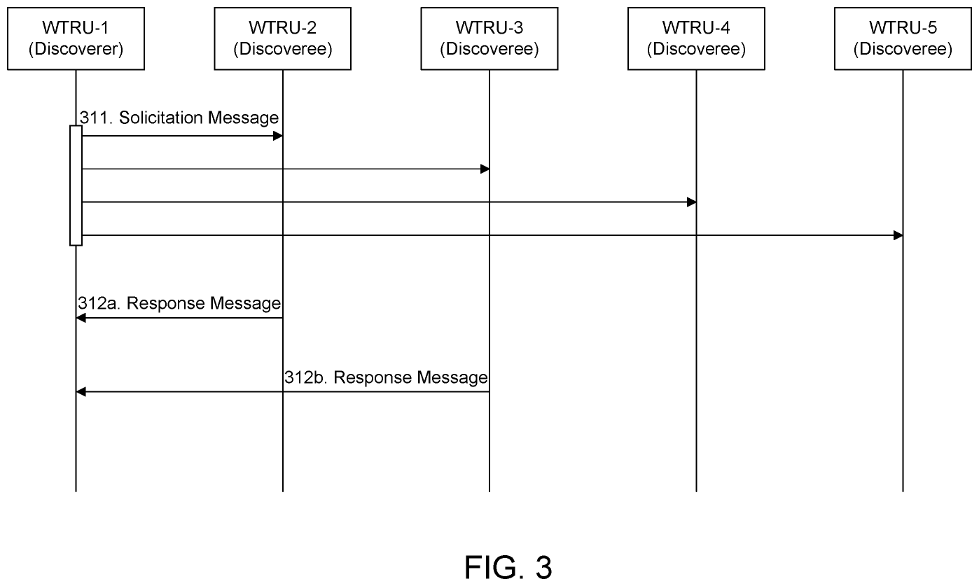

In model B, as illustrated in FIG. 3, a WTRU (e.g., discoverer WTRU) may broadcast a solicitation request message (311), for example, with ProSe Query code (which may be associated with WTRU's ID to be discovered or associated to ProSe service to be discovered). Other WTRUs who received the Solicitation request message (discovered WTRU) may respond to the request (312a, 312b), for example, with the ProSe response code (which may be associated with discoveree WTRU's ID or associated with the ProSe service provided by the discoveree WTRU). The discoverer WTRU knows the discoveree WTRU may be in proximity.

Both discovery modes can be used to perform Group discovery (to discover WTRUs belong to a specific group), WTRU-to-Network relay discovery (to discover a WTRU-to-Network relay that provides a connection with a 5G network).

For Group discovery, the discovery message (Announcement, Solicitation Request/Response) may additionally include Group ID. For WTRU-to-Network relay discovery, the discovery message (Announcement, Solicitation Request/Response) may use relay service code (instead of ProSe code) to indicate WTRU-to-Network relay service.

### WTRU to Network Relay

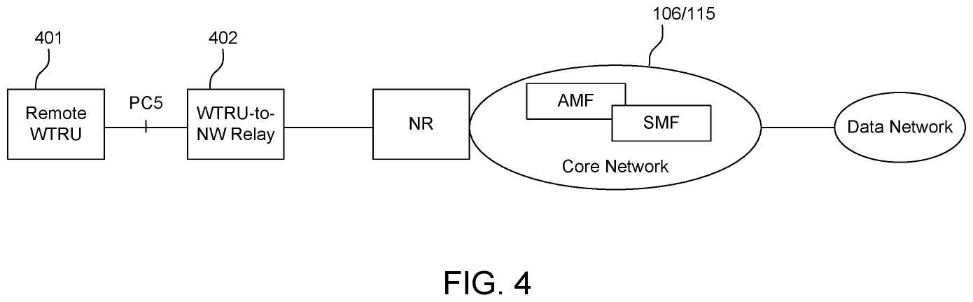

As illustrated in FIG. 4, the ProSe WTRU-to-Network Relay entity 402 may provide the functionality to support connectivity to the network for remote WTRUs 401.

If the remote WTRU 401 is out of NR coverage and cannot communicate with the core network 106/115 directly (or in NR coverage but prefers to use unicast (e.g., PC5) for communication), the remote WTRU 401 may discover and select a WTRU-to-Network relay/(e.g., relay) WTRU 402. The remote WTRU 401 may establish a unicast (e.g., PC5) session with WTRU-to-Network Relay 402 and, the WTRU-to-Network Relay 402 may establish a PDU session (or PDN connection in evolved packet core (EPC)) for the remote WTRU 401 or the remote WTRU 401 may establish a PDU session via the (e.g., relay) WTRU 402. After IP address/prefix allocation, the traffic between remote WTRU 401 and network may be relayed by WTRU-to-Network Relay 402.

### Trust Assertions

The following subsections provide background information for two modes (models) of trustworthiness verification.

### Passport Model

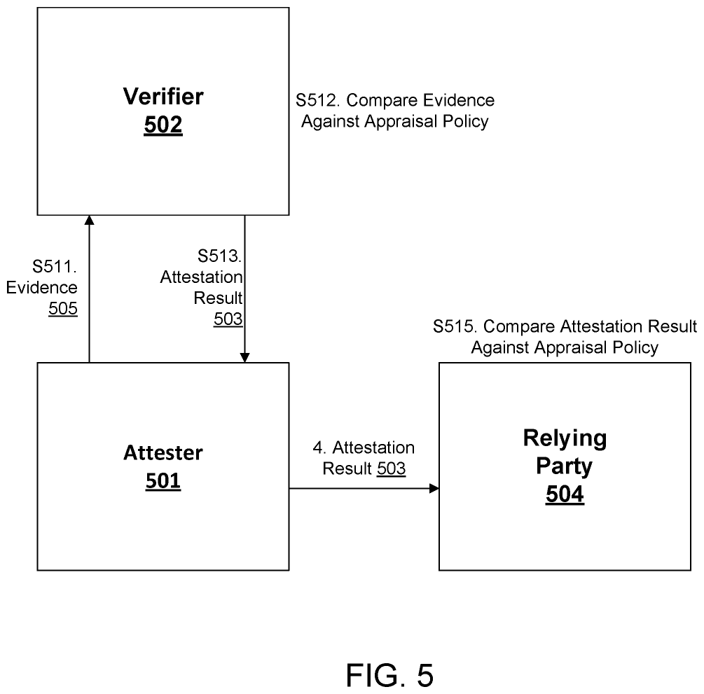

The passport model, as illustrated in FIG. 5, may be so named because of its resemblance to how nations issue passports to their citizens. The nature of the evidence that an individual may (e.g., needs to) provide to its local authority is specific to the country involved. The citizen retains control of the resulting passport document and presents it to other entities such as an airport immigration desk when it may (e.g., needs to) assert a citizenship or identity claim. The passport may be considered sufficient because it vouches for the citizenship and identity claims, and it is issued by a trusted authority. Thus, in this immigration desk analogy, the citizen is an attester 501, the passport issuing agency is a verifier 502, the passport is an attestation result 503, and the immigration desk is a relying party 504.

In this model, an attester 501 may convey evidence 505 to a verifier 502 (S511), which may compare the evidence 505 against its appraisal policy (S512). The verifier 502 (e.g., then) may give back an attestation result 503 (S513). If the attestation result 503 was a successful one, the attester 501 can (e.g., then) present the attestation result 503 (and possibly additional claims) to a relying party 504 (S514), which may compare this information against its appraisal policy (S515).

The evidence 505 in this context may be any parameter of a set of parameters that an individual (a WTRU, relay, function, etc., in the context of telecommunication) provides to the verifier functional entity 502.

The appraisal policy in the context of trustworthiness may include any combination of one or more conditions that are met in the Evidence. For example, “all required SW updated performed”=TRUE.AND. “hardware enclosure locked”=TRUE.

The process above may fail in any of the following cases:
The verifier 502 may not issue a positive attestation result 503 due to the evidence 505 not passing the appraisal policy for evidence.
The process may fail when the attestation result 503 may be examined by the relying party 504, and based upon the appraisal policy for attestation results, the result does not pass the policy.
The process may fail when the verifier 502 may be unreachable or unavailable.

Note that the attestation result 503 (e.g., passport) may be designed in such a manner that the relying party 504 (e.g., airport immigration desk) may not need to be online to examine the attestation results against its appraisal policy.

### Background-Check Model

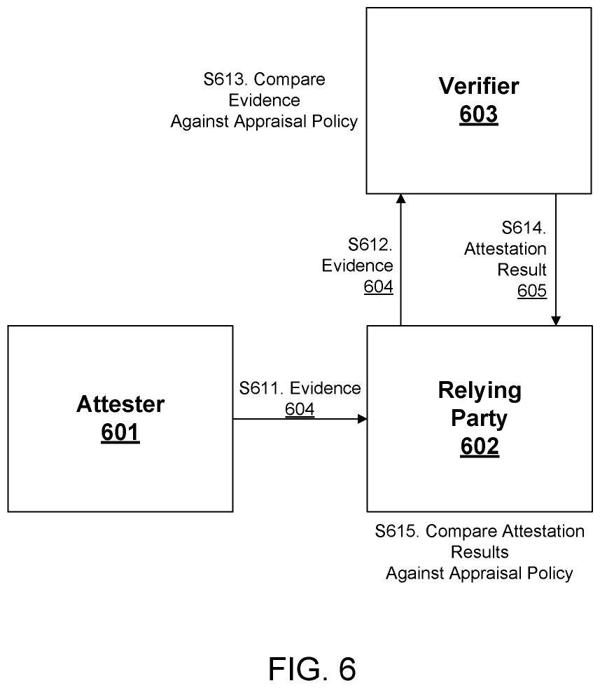

The background-check model, as illustrated in FIG. 6, is so named because of the resemblance of how employers and volunteer organizations perform background checks. When a prospective employee provides claims about education or previous experience, the employer will contact the respective institutions or former employers to validate the claim. Volunteer organizations often perform police background checks on prospective employees to determine the prospective employee's trustworthiness. Thus, in this analogy, a prospective employee is an attester 601, the employer is the relying party 602, and the organization that issues a report is a verifier 603.

In this model, an attester 601 may convey evidence 604 to a relying party 602 (S611), which, may pass it on to a verifier 603 (S612). The verifier 603 (e.g., then) may compare the evidence 604 against its appraisal policy (S613), and may return an attestation result 605 to the relying party 602 (S614). The relying party 602 may compare the attestation result 605 against its appraisal policy (S615).

The resource access protocol between the attester 601 and relying party 602 may include evidence 604 rather than an attestation result 605, but that evidence 604 is not processed by the relying party 602. Since the evidence 604 may be (e.g., merely) forwarded on to a trusted verifier, any serialization format can be used for evidence because the relying party 602 may not use (e.g., need) a parser for it. the (e.g., only) requirement may be that the evidence 604 can be encapsulated in the format used (e.g., required) by the resource access protocol between the attester 601 and relying party 602.

Similar to the passport model, an attestation result may be still consumed by the relying party.

During the selection of relay WTRU (either WTRU to Network Relay or WTRU to WTRU Relay) it may be desirable to base the decision to select a particular relay WTRU based on its trustworthiness.

Relay WTRU may be assumed to be a trusted entity. This type of trust may be called “trust by fiat” or, colloquially, “because I decided so.” While such assumption about the trust in ProSe Relay may be convenient, it may not address high-value use cases where the nature of services supported by the ProSe Relay may use (e.g., requires) the trust placed on the ProSe Relay to be based on evidence and/or not on an assumption and/or fiat.

Any the following may be provided: techniques for the WTRU to verify that the relay WTRU's claimed trustworthiness and/or properties (e.g., supported services) are valid and/or allowed; techniques for the relay WTRU to check if the remote WTRU's properties are what is being claimed; techniques to enable the remote WTRU to assess the trustworthiness of a ProSe Relay (e.g., prior to using services provided via such relay).

The proposed techniques herein define possible ways to assert claims of trustworthiness from the ProSe Relay to the remote WTRU (e.g., to select relay WTRU based on the trustworthiness) or from the remote WTRU to the relay WTRU (e.g., to allow (e.g., only) remote WTRUs that are trustworthy to use the relay WTRU).

The evidence of the relay WTRU trustworthiness may be initially obtained by the participating relay WTRU (see passport Model) and/or analyzed on the spot by the remote WTRU (see background-check model). Note that the nature of the background-check model may use (e.g., require) online verification of the Attestation evidence by the Verifier. If a “direct” online verification is used (e.g., required), it may use (e.g., needs) connectivity to the Verifier and may not be advisable when the corresponding solution has to work out of coverage. It can be stated that indirect connectivity, e.g., access to a Verifier using control plane signaling relayed to the network, is possible to use when direct connectivity may not be obtainable. In addition, a remote WTRU may be able to establish secure end-to-end communication with a verifier (AF) to obtain trustworthiness evidence.

While proposed embodiments focus on L3 Relays where the relay WTRU establishes the PDU session for the remote WTRU, L2 Relay solutions where the remote WTRU establishes the PDU session and the relay only relays packets are also possible.

### Assertion Claims of Trustworthiness From the ProSe Relay to the Remote WTRU

Assertion of trustworthiness from the relay WTRU may be obtained by the remote WTRU before it is connected to the macro cellular network through the relay WTRU and therefore before the remote WTRU can contact the verifier to obtain attestation result from the Verifier. The Background-Check Model may use (e.g., require) connectivity to the Verifier while the Passport Model can be configured in such a way that the remote WTRU (Relying Party) will be able to inspect Attestation Results coming from the relay WTRU (Attester) and compare them against its Appraisal Policy.

Attestation Results may be obtained during or after the relay discovery procedure, and prior to the relay selection procedure completion and/or unicast (e.g., PC5) link establishment completion with the relay WTRU.

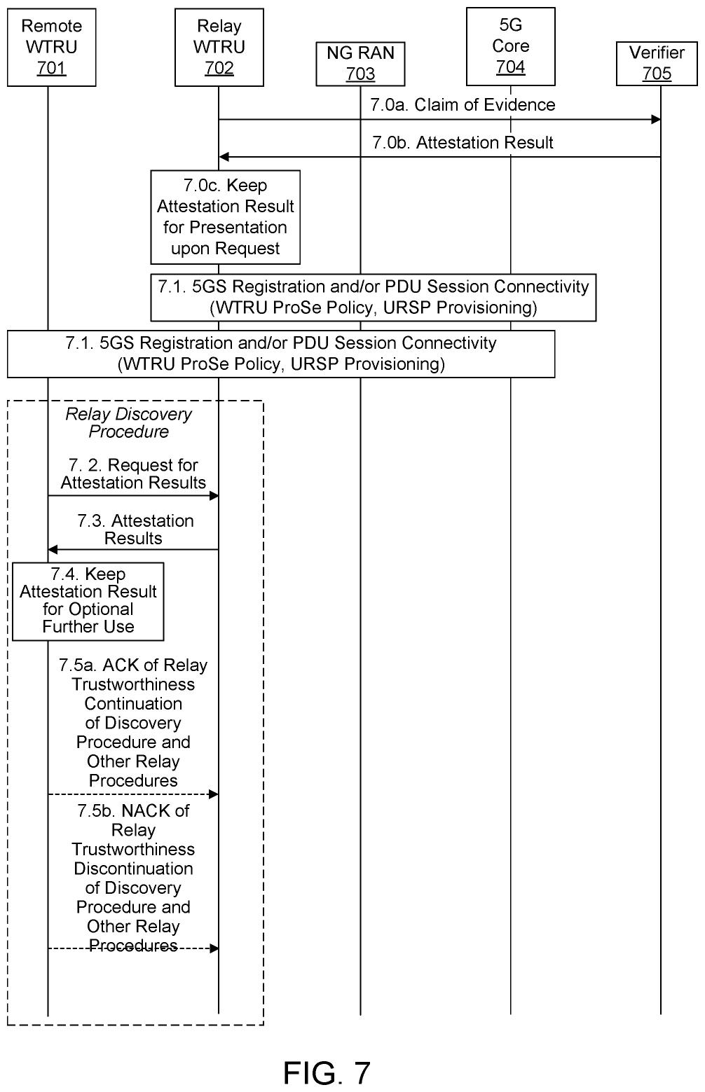

FIG. 7 illustrates a relay discovery procedure with relay WTRU trustworthiness, the method comprising any of the following actions:
7.0a: The (e.g., relay) WTRU 702 may supply claims of its trustworthiness to the verifier 705.
7.0b: The verifier 705 may reply to the (e.g., relay) WTRU 701 with processed Attestation Results, for example, along with a valid time that may be signed by the Verifier's private key.
7.0c: The (e.g., relay) WTRU 702 may keep the Attestation Results received from step 7.0b for further presentation upon request.
7.1: Network (e.g., 5GS/5G system) registration and/or PDU session connectivity establishment procedures with the RAN 703 and/or the core network 704 for remote and (e.g., relay) WTRUs.
7.2: The (e.g., remote) WTRU 701 may request the attestation Results from the (e.g., relay) WTRU during the unicast (e.g., PC5) discovery procedure.
7.3: The (e.g., relay) WTRU 702 may provide its attestation results (e.g., from step 7.0c) to the (e.g., remote) WTRU 701 which may verify the (e.g., relay) WTRU trustworthiness using verifier's public key.
7.4: The (e.g., remote) WTRU 701 may keep the attestation Results received from step 7.3 (or may remember that this particular (e.g., relay) WTRU 702 may be trusted e.g., within the validity time or pre-configured in the policy conditions). Saved attestation results may be re-used for further attestation if the policy allows skipping steps 7.2 and 7.3, e.g., if the (e.g., remote) WTRU 701, later on, discovers this (e.g., relay) WTRU 702 again, (e.g., then) steps 7.2 and/or 7.3 may be skipped based on the saved attestation results. A validity timer may be associated with the attestation results. At the expiration of such validity timer, the attestation of results may be deleted from (e.g., remote) WTRU 701. The (e.g., remote) WTRU 701 can keep attestation results for further decision-making (e.g., (e.g., remote) WTRU 701 compares trustworthiness of more than one (e.g., relay) WTRU and subsequently selects a path through the most trusted (e.g., relay) WTRU and/or path switch based on trustworthiness.)
7.5a: Positive acknowledgment (success) of the (e.g., relay) WTRU attestation procedure. The (e.g., remote) WTRU may proceed with the unicast (e.g., PC5) link establishment procedure with the (e.g., relay) WTRU, for example, after sending the ACK message and/or may skip the ACK message and proceed (e.g., right away) with the unicast (e.g., PC5) link establishment.
7.5b: Negative acknowledgment (failure) of the (e.g., relay) WTRU attestation procedure. The (e.g., remote) WTRU 701 may send a NACK message to the (e.g., relay) WTRU 702. The (e.g., remote) WTRU 701 may not proceed with the unicast (e.g., PC5) link establishment with this (e.g., relay) WTRU 702.

The (e.g., relay) WTRU 702 discussed in this section may be a WTRU-to-Network Relay. The principles of attestation of trustworthiness may apply to a WTRU-to-WTRU relay as well, e.g., a WTRU which establishes an end-to-end unicast (e.g., PC5) link with a peer WTRU, via a WTRU-to-WTRU relay, may verify the WTRU-to-WTRU relay trustworthiness prior to establish an end-to-end unicast (e.g., PC5) link with a peer WTRU via this WTRU-to-WTRU relay.

### Assertion of Trustworthiness Procedures

Assertion of trustworthiness may be done using various procedures, e.g., unicast (e.g., PC5) discovery or unicast (e.g., PC5) link establishment. In addition, the passport or background-check models or their combination may be used. Details are provided in the following sub-sections.

The terminology “Relay” or “Relay WTRU” may refer to a WTRU-to-Network relay and/or a WTRU-to-WTRU Relay (unless otherwise specified).

Remote WTRU may be used to identify the WTRU connecting to the network via a WTRU-to-Network Relay. It may be used as well in this document to identify a WTRU connecting to a WTRU-to-WTRU Relay.

### Using Attestation Results

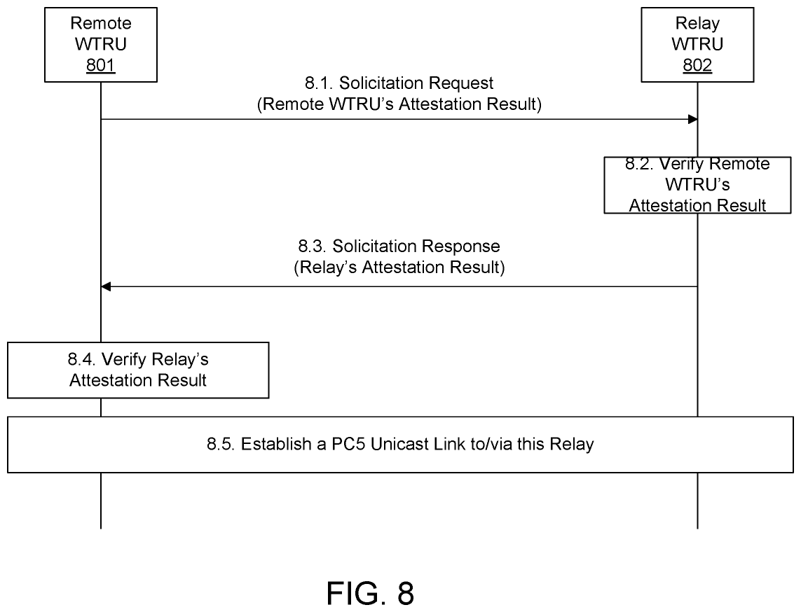

FIG. 8 illustrates Assertion of trustworthiness of (e.g., remote) WTRU 801 and (e.g., relay) WTRU 802 using Solicitation procedure.

During Discovery procedure (Solicitation Request/Response):
8.1—The (e.g., remote) WTRU 801 may send to the (e.g., relay) WTRU 802, a solicitation request message which may include its attestation result.
8.2—In the case where it receives the Solicitation Request message, the (e.g., relay) WTRU 802 may check the digital signature of the (e.g., remote) WTRU's attestation using Verifier's public key and its validity time, and/or it may compare the attestation result against its appraisal policy.
8.3—If the (e.g., remote) WTRU's attestation result is successfully verified, the (e.g., relay) WTRU 802 may send a solicitation response message, for example, including its attestation result; if the (e.g., remote) WTRU's attestation result is not successfully verified, the relay 802 may not send a solicitation response.
8.4—In the case where it receives the solicitation response message, the (e.g., remote) WTRU 801 may check the signature of the relay's attestation using Verifier's public key and its validity time, and/or it may compare the relay's attestation result against its appraisal policy.
8.5—If successful, the (e.g., remote) WTRU 801 may select this relay 802 and/or trigger unicast (e.g., PC5) link establishment. If not successful, the (e.g., remote) WTRU 801 may not trigger unicast (e.g., PC5) link establishment with this relay 802 and may internally keep track of this relay and its unsuccessful verification (e.g., on a blacklist of Relays), for a period of time/some time.

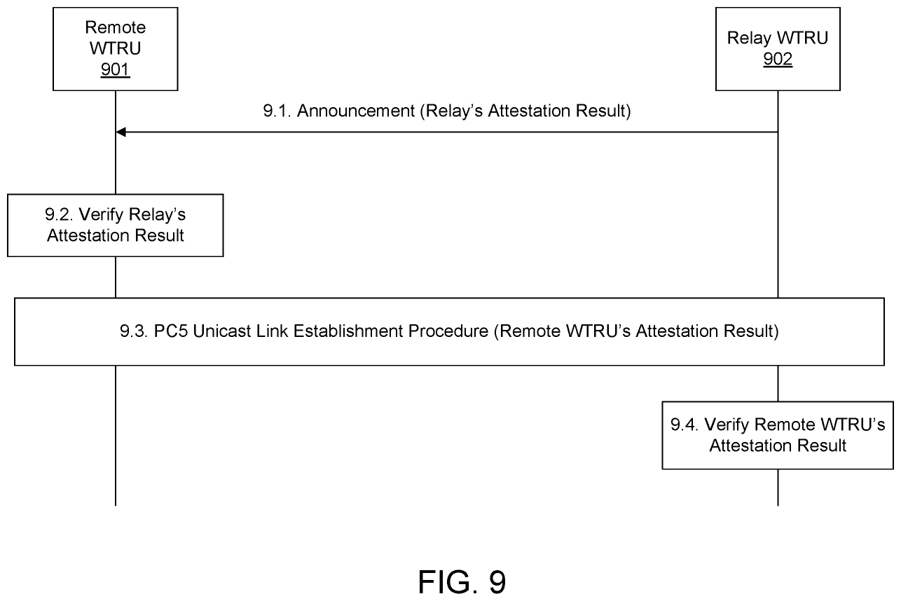

FIG. 9 illustrates Assertion of trustworthiness of (e.g., remote) WTRU 901 and (e.g., relay) WTRU 902 using Announcement procedure.

During Discovery procedure (Announcement):
9.1—The (e.g., relay) WTRU 902 may send to the (e.g., remote) WTRU 901 an announcement message including its attestation result.
9.2—In the case where it receives the announcement message, the (e.g., remote) WTRU 901 may check the signature of the (e.g., relay) WTRU's attestation, for example, using Verifier's public key and its validity time, and/or it may compare the attestation result against its appraisal policy.
9.3—If successful, the (e.g., remote) WTRU 901 may select this (e.g., relay) WTRU 902 and trigger unicast (e.g., PC5) link establishment. Remote WTRU 901 may send its attestation result e.g., on the direct communication request (DCR) message, and/or include it during the authentication or security mode procedures (e.g., on Authentication Response or Direct Security Mode Complete message)
9.4—In the case where it receives the (e.g., remote) WTRU's attestation result, the (e.g., relay) WTRU 902 may check the signature of the (e.g., remote) WTRU's attestation using Verifier's public key and its validity time, and/or it may compare it against its appraisal policy. If successful, the (e.g., relay) WTRU 902 may continue the unicast (e.g., PC5) link establishment procedure. If not successful, the (e.g., relay) WTRU may stop the unicast (e.g., PC5) link establishment procedure, for example, by not responding to the messages from the (e.g., remote) WTRU 901 and/or by sending a reject message (e.g., Authentication Failure message or Direct Security Mode Reject message, or Direct Communication Reject message).

The (e.g., relay) WTRU 902 may internally keep track of this (e.g., remote) WTRU 901 and its unsuccessful verification (e.g., put it on a blacklist of (e.g., remote) WTRUs), for a period of time/some time.

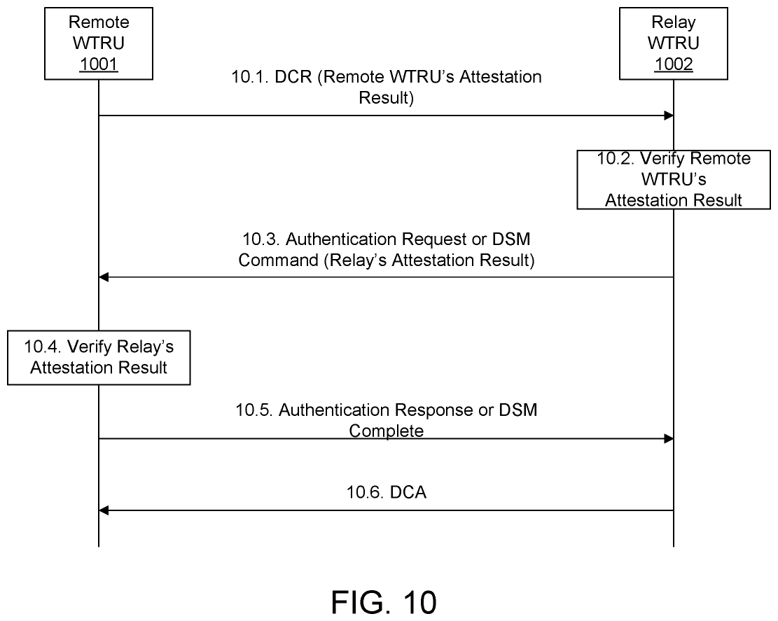

FIG. 10 illustrates Assertion of trustworthiness of (e.g., remote) WTRU 1001 and (e.g., relay) WTRU 1002 during unicast (e.g., PC5) link establishment procedure.

During unicast (e.g., PC5) link establishment (no attestation of trust during Discovery or no Discovery):
10.1—The (e.g., remote) WTRU 1001 may send to the (e.g., relay) WTRU 1002 a (e.g., DCR) message which includes its attestation result.
10.2—In the case where it receives the (e.g., DCR) message, (e.g., relay) WTRU 1002 may check the signature of the (e.g., remote) WTRU's attestation using Verifier's public key and its validity time, and/or it may compare the attestation result against its appraisal policy.
10.3—If successful, the (e.g., relay) WTRU 1002 may send its attestation result, for example, during the authentication or security mode procedures (e.g., in Authentication Request or Direct Security Mode Command message); if not successful, the (e.g., relay) WTRU 1002 may stop the unicast (e.g., PC5) link establishment procedure, for example, by not responding to the DCR message and/or by sending a reject message (e.g., Direct Link Communication Reject including a cause value e.g., trustworthiness failure).
10.4—In the case where it receives the (e.g., relay) WTRU's attestation result, the (e.g., remote) WTRU 1001 may check the digital signature of the (e.g., relay) WTRU's attestation using Verifier's public key and its validity time, and/or it may compare the attestation result against its appraisal policy.
10.5—If successful, the (e.g., remote) WTRU 1001 may continue the link establishment procedure; if not successful, the (e.g., remote) WTRU 1001 may stop the unicast (e.g., PC5) link establishment procedure, for example, by not responding to the DCR message and/or by sending a reject message (e.g., Direct Link Communication Reject).
10.6—The (e.g., relay) WTRU 1002 may send a direct communication accept (DCA) message and the unicast (e.g., PC5) unicast link may be established.

According to an embodiment, the (e.g., remote) WTRU 1001 may send its attestation of result, for example, using the Direct Security Mode (DSM) Complete message (instead of including the DCR message) and then the (e.g., relay) WTRU 1002 may send its attestation of result, for example, using the DCA message. In the case where it receives the DCA message for example, the (e.g., remote) WTRU 1001 may tear down the link if it cannot successfully verify the (e.g., relay) WTRU's attestation result.

There may be no need to redo Attestation Results to check if authentication and/or security procedures are re-executed, e.g., periodically.

### Using Attestation of Evidence

According to some embodiments, the steps described in the section above (“Using attestation results) may be re-used with both remote WTRU and relay WTRU providing their attestation of evidence instead of their attestation of result. The remote WTRU and relay WTRU may (e.g., need to) have access to the network to obtain the attestation of results from the Verifier. According to some embodiments, if the Verifier already has the evidence of the WTRU, the WTRU ID can be sent to the Verifier to get the attestation:

### 1) During Discovery Procedure (Solicitation Request/Response):

a) The remote WTRU may send a solicitation request message including its attestation of evidence. The attestation evidence may be integrity and/or replay protected between the WTRU and Verifier.
b) The relay WTRU may send an attestation request message including the evidence to the Verifier and/or may wait for reception of attestation results before sending (or not) a solicitation response message, including its attestation evidence. The attestation evidence may be signed by the Verifier.
c) The remote WTRU may send an attestation request including the evidence from the relay WTRU to the verifier to obtain the attestation of the result.

### 2) During Discovery Procedure (Announcement):

a) The relay WTRU may send an announcement message including its attestation of evidence.
b) The remote WTRU may send an attestation request including the evidence from the relay WTRU to the verifier to obtain the attestation of the result.

### 3) During Unicast (e.g., PC5) Link Establishment (No Attestation of Trust During Discovery or No Discovery):

a) The remote WTRU may send a DCR message which may include its attestation of evidence.
b) At the reception of the DCR message, the relay WTRU may send an Attestation Request including the evidence to a relying party and wait for reception of Attestation Results.
c) If verification of the remote WTRU's attestation of Result is successful, the relay may send its attestation of evidence to the remote WTRU during the authentication procedure or security establishment procedure.
d) The remote WTRU may send the relay WTRU's evidence to a relying party to obtain the relay WTRU's attestation result and continue with the procedure as described in the section above (“Using attestation results).

### Using a Mix of Attestation Result and Evidence

A combination of evidence and attestation of the result may be used. This may be useful, e.g., in a case where a WTRU-to-Network Relay (which may (e.g., always) network access) is used and a remote WTRU (which may not have network access) is used.

The steps described in the section above (“Using attestation results) may be re-used with the remote WTRU providing its evidence and with the relay WTRU providing its attestation of result. The relay WTRU may obtain the remote WTRU's attestation of result from a relying party. The remote WTRU may be configured with the appraisal policy. The Verifier function may be co-located with an AF such as prose key management function (PKMF), or a direct discovery name management function (DDNMF). The verifier function may be reached over user plane when the remote WTRU is in coverage. The remote WTRU may be configured by the verification function (e.g., PKMF) with a local policy while in-network coverage. For example, the remote WTRU may use its local policy to verify relay attestation evidence while out of coverage and request the verifier AF to verify the relay attestation evidence while in coverage. The remote WTRU may request attestation verification from the verifier AF during discovery, during, or after unicast (e.g., PC5) link establishment.

### Network Controlled Assertion of Relay Trustworthiness

A remote WTRU may perform an assessment of relay trustworthiness of relay WTRU during a network controlled authorization.

Pre-condition: the remote WTRU may discover and/or may select a relay WTRU that broadcasts an indication of attestation capability or relay service code (RSC) associated with such indication.

The remote WTRU may perform any of the following actions:
The remote WTRU may send a connection request including a network identity (e.g., subscription concealed identifier (SUCI)) and/or an indication requesting attestation result.
The remote WTRU may perform a primary authentication procedure, for example, via the relay WTRU and/or derive a network access key and/or relay access key material, for example, during the procedure.
The remote WTRU may receive a message, for example, during a security mode command procedure, including relay attestation results protected (e.g., for integrity with a MAC, for example) using the network access key.
The remote WTRU may verify the attestation results protection, for example, using the network access key and/or pass the results to the upper layer for further assessment.
The remote WTRU may proceed with connection establishment in case of (e.g., upon) acceptance of attestation results from the upper layer (e.g., application layer) and/or may abort the connection establishment procedure.

The relay WTRU may perform any of the following actions:
The relay WTRU may receive a connection request from a remote WTRU including a network identity (e.g., SUCI) and/or an indication requesting attestation result.
The relay WTRU may send a request message to the network (e.g., an AMF) including claims of evidence.
The relay WTRU may receive a response message from the network including protected Relay attestation (e.g., at least integrity protected with an included MAC using a network access key or verifier private key as described below) and/or relay access key material.
The relay WTRU may send a request message to the remote WTRU, for example, during a security mode command procedure, including the protected Relay attestation results.
The relay WTRU may proceed with connection establishment in case of (e.g., upon) successful completion of the Security Mode procedure, for example, using the relay access key material.

The network (e.g., AMF) may perform any of the following actions:
The network (e.g., AMF) may receive a request message from a relay WTRU for a remote WTRU authorization, the message including claims of evidence from the relay.
The network (e.g., AMF) may initiate a primary authentication procedure of the remote WTRU, for example, via the relay WTRU and/or may derive a network access key during the procedure.
In case of (e.g., upon) successful authentication of the remote WTRU, the AMF may send a request message to a Verifier (e.g., an Application Function) including relay identity (e.g., generic public subscription identifier (GPSI)), the claims of evidence from the relay.
The network (e.g., AMF) may receive a response message including attestation results for the relay WTRU and/or validity time that may be protected with Verifier's digital signature.
The network (e.g., AMF) may send a response message to the relay WTRU including the attestation results, for example, integrity protected, for example, using the network access key or verifier (e.g., AF) private key, where the key may be known to remote WTRU and network or verifier but unknown to relay WTRU (e.g., key stored in the AUSF in a authentication server function (AUSF) (KAUSF), key stored in the AMF (KAMF), verifier private key of a public key pair), and message may be protected, for example, using relay WTRU access key material.

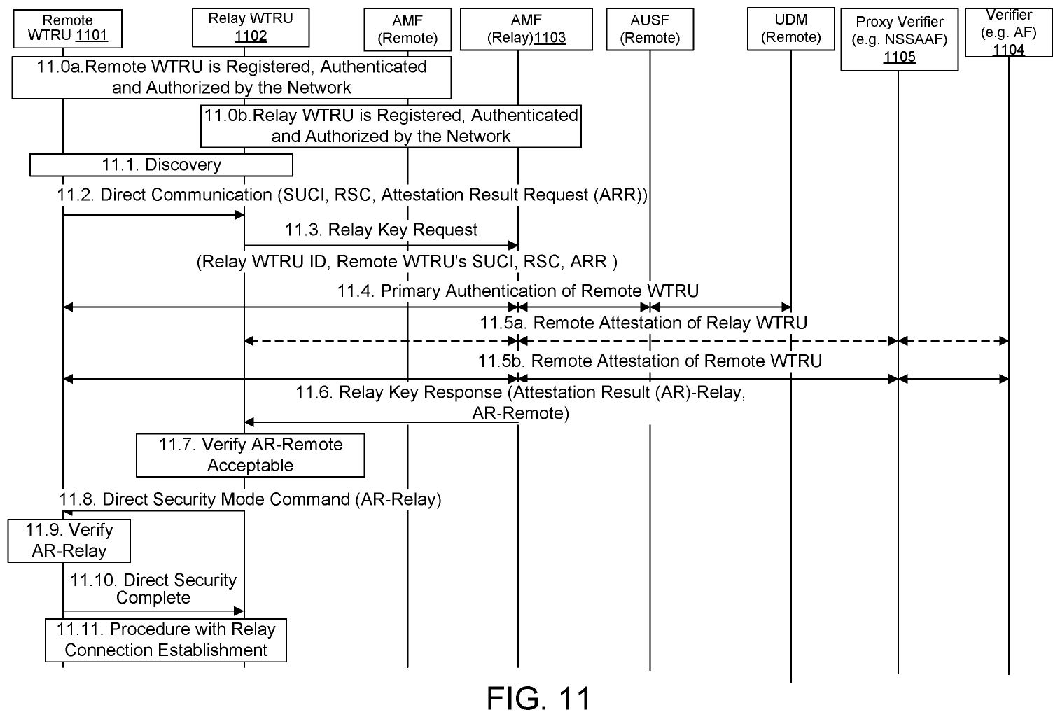

FIG. 11 illustrates an example of a method for relay connection establishment using network-assisted remote attestation, the method comprising any of the following actions:
11.0a/11.0b—The (e.g., remote) WTRU 1101 and (e.g., relay) WTRU 1102 may be registered and/or configured, for example, with an RSC associated with a remote attestation required parameter. The (e.g., remote) WTRU 1101 and/or (e.g., relay) WTRU 1102 may be provisioned with an appraisal policy (e.g., at the application layer).
11.1—The (e.g., remote) WTRU 1101 may discover the (e.g., relay) WTRU 1102 that provides service for the RSC.
11.2—The (e.g., remote) WTRU 1101 may send a (e.g., DCR) message including any of: SUCI, RSC, and attestation result request (ARR) indication according to RSC's Remote Attestation requirement parameter.
11.3—The (e.g., relay) WTRU 1102 may send a relay key request message including remote and relay identities, RSC and ARR.
11.4—The (e.g., remote) WTRU 1101 may perform a primary authentication, for example, via the (e.g., relay) WTRU's network node 1103 (e.g., AMF).
11.5a/11.5b—After successful primary authentication, the (e.g., relay) WTRU's network node 1103 (e.g., AMF) may initiate a Remote Attestation procedure of the (e.g., relay) WTRU 1102 and (e.g., remote) WTRU 1101 with a Verifier (e.g., AF) 1104 via a proxy Verifier 1105 (e.g., network slice-specific authentication and authorization function (NSSAAF)). The network node 1103 (e.g., AMF) may send the identity of WTRU subject to remote attestation, identifier of the service/resource for which the remote attestation may be requested before granting access (e.g., single network slice selection assistance information (S-NSSAI), data network name (DNN), RSC). The Remote attestation procedure may be executed between the WTRU and the verifier 1104 over NAS transport with AMF/Proxy acting as intermediaries. The network node 1103 (e.g., AMF) may store the attestation result (AR) for the relay WTRU 1102/remote WTRU 1101 and use it in a subsequent relay connection request with ARR (e.g., during device to device (D2D) communications, as a relay as described above, e.g., path switch based on trustworthiness). The AR may be securely bound to a validity time, location, public land mobile network (PLMN), and/or RSC(s). The transmitted AR may be protected by Verifier 1104 and/or network node 1103 (e.g., AMF) (e.g., with Verifier signature, MAC by AMF).
11.6—The (e.g., relay) WTRU 1102 may receive AR for (e.g., relay) WTRU 1102 and (e.g., remote) WTRU 1101 from the network node 1103 (e.g., AMF).
11.7—The (e.g., relay) WTRU 1102 may verify that (e.g., remote) WTRU's AR may be acceptable (e.g., against an appraisal policy).
11.8—The (e.g., relay) WTRU 1102 may send to the (e.g., remote) WTRU 1101 the (e.g., relay) WTRU's AR, for example, in a protected DSM Command message.
11.9—The (e.g., remote) WTRU 1101 may verify that (e.g., relay) WTRU's AR may be acceptable (e.g., against an appraisal policy).
11.10—The (e.g., remote) WTRU 1101 may send a DSM Complete message to complete the unicast (e.g., PC5) link setup.
11.11—The (e.g., remote) WTRU 1101 and (e.g., relay) WTRU proceed with the rest of the relay connection procedure.

According to some embodiments, the remote WTRU may obtain attestation results from a PKMF (e.g., with or exposing Verifier capabilities) if (e.g., when) providing claims of evidence to the PKMF. The remote WTRU may receive protected attestation results from PKMF (e.g., signed by the remote WTRU's PKMF) in case of the request of a key to access a relay service. According to embodiments, the remote WTRU may receive a relay access key, for example, on the condition that the remote WTRU attestation results satisfy certain trustworthiness criteria (e.g., established for the relay service, RSC). The remote WTRU may determine the requirements to produce claims of evidence when requesting a relay access key based on the RSC configuration indicating attestation by PKMF may be used (e.g., required) to obtain access to the relay service. The relay WTRU may perform similar steps with its PKMF to be granted authorization to provide the relay service.

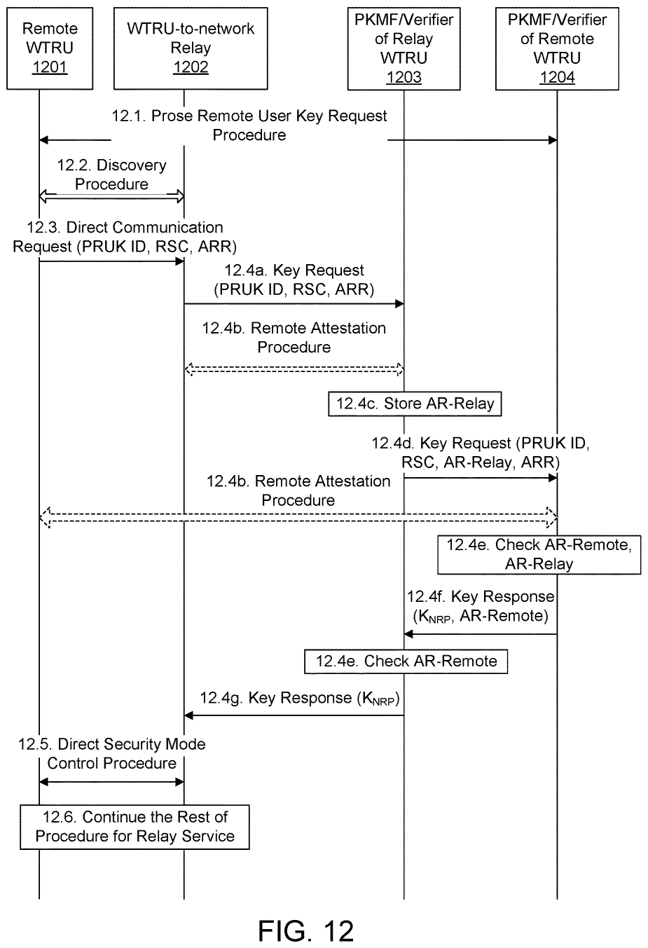

FIG. 12 illustrates an exemplary method for relay connection establishment using PKMF assisted remote attestation, the method comprising any of the following actions:
12.1—The (e.g., remote) WTRU 1201 may perform a key request procedure with its PKMF 1204. The key request may include a request for attestation results. The (e.g., remote) WTRU 1201 may obtain a new prose remote user key (PRUK)/PRUK ID, for example, after completing successfully the remote attestation procedure.
12.2—The (e.g., remote) WTRU 1201 may discover the (e.g., relay) WTRU 1202 that provides service for the RSC.
12.3—The (e.g., remote) WTRU 1201 may send a (e.g., DCR) message including any of: PRUK ID, RSC, and ARR indication.
12.4—The (e.g., relay) WTRU 1202 may send a (e.g., key request) message including any of: PRUK ID, RSC, and ARR to its PKMF 1203 (12.4a). The relay WTRU's PKMF 1203 may initiate a remote attestation procedure with (e.g., relay) WTRU (e.g., if no valid AR is available for the Relay/RSC) (12.4b). The (e.g., relay) WTRU's PKMF 1203 may store the AR from the (e.g., relay) WTRU 1202 (12.4c). The (e.g., relay) WTRU's PKMF 1203 may send the key request message to the (e.g., remote) WTRU's PKMF 1204 forwarding parameters from relay and the AR for the (e.g., relay) WTRU 1202 (e.g., AR-Relay) (12.4d). The (e.g., remote) WTRU's PKMF 1204 may initiate a remote attestation procedure with the (e.g., remote) WTRU (e.g., if no valid AR is available for the (e.g., remote) WTRU/RSC) (12.4b). If AR for the (e.g., remote) WTRU 1201 and/or the (e.g., relay) WTRU 1202 are acceptable (12.4e) (e.g., based on appraisal policy for the RSC/S-NSSAI/DNN) the (e.g., remote) WTRU's PKMF 1204 may send a key response message to the (e.g., relay) WTRU's PKMF 1203 including the (e.g., remote) WTRU 1201 (e.g., AR-Remote) (12.4f). The (e.g., relay) WTRU's PKMF 1204 may check that the AR for the (e.g., remote) WTRU 1201 (e.g., AR-Remote) is acceptable (12.4e). The Relay WTRU's PKMF 1204 may send a key response message to the (e.g., relay) WTRU 1202 to authorize the unicast (e.g., PC5) link establishment (12.4g).
12.5—The (e.g., remote) WTRU 1201 and the (e.g., relay) WTRU 1202 may perform a direct security mode control (DSMC) procedure.
12.6—The (e.g., remote) WTRU 1201 and the (e.g., relay) WTRU 1202 may proceed with the rest of the relay connection procedure.

### Assertion of WTRU Trustworthiness Based on Remote Attestation During PDU Session Establishment Using an Authentication/Attestation Server

According to embodiments, a WTRU (e.g., acting as a relay) trustworthiness may be established based on the resource being accessed such as e.g., S-NSSAI, DNN during a session management procedure. An example may be that of a WTRU (e.g., Relay) that wishes to access or provide access to a sensitive resource (e.g., a sensitive/government agency DN).

A WTRU remote attestation may be performed by an attestation server (e.g., co-located with an authentication, authorization, and accounting (AAA) server) as part of an enhanced PDU Session with secondary authentication and/or attestation. The WTRU may perform remote attestation which may take place following an authentication message exchange with the authentication server. The SMF may determine that (e.g., supplemental) remote attestation may be used (e.g., required) based on subscription information associated with DNN or based on local configuration. The remote attestation protocol with the AAA server may be performed (e.g., using extensible authentication protocol (EAP) or other transport) via SMF over NAS transport. The remote attestation evidence/result (e.g., as a AAA signed token, signed by the verifier) may be provided by the AAA server via the network to WTRU (e.g., in a NAS message, PDU Session establishment accept or reject). Based on the AAA server's appraisal policy, the AAA may provide a positive or negative result to the network/WTRU, and the network (SMF) may accept or reject the PDU Session establishment accordingly. The WTRU may use the attestation result in subsequent procedures for communicating with other WTRUs or a network entity.

According to embodiments the WTRU (e.g., acting as a relay) may present the remote attestation evidence to remote WTRUs (e.g., in a broadcast message or during link establishment as per the above embodiments) that may wish to use the relay service. According to embodiments, the WTRU may act as a residential gateway or the like. According to embodiments, the WTRU may present such attestation result when connecting with a server (e.g., an edge network server). The remote WTRU and relay WTRU may be configured with a RSC associated with an indication of assertion claims of trustworthiness requirements. Based on this indication the relay WTU may be expected to obtain and present trustworthiness info evidence as per the above embodiment. The remote WTRU may determine whether to select/connect with a relay WTRU based on trustworthiness requirements indication and Relay provided trustworthiness info evidence. For example, remote WTRU may select/connect with the relay WTRU if the trustworthiness info satisfies remote WTRU's appraisal policy (e.g., configured with RSC). The appraisal policy may specify a required minimum value of trustworthiness, for example, based on a scoring system (e.g., above 80%, 100%).

The remote attestation server in this embodiment may be a network function (NF) in the mobile network operator (MNO) domain or operated by a 3rd party (e.g., an AF, remote attestation server). If operated by a 3rd party, the remote attestation server may communicate with the core network via a network exposure function (NEF). As an NF in the MNO domain, the attestation server may be co-located with or provided as a service of an existing function (e.g., AUSF).

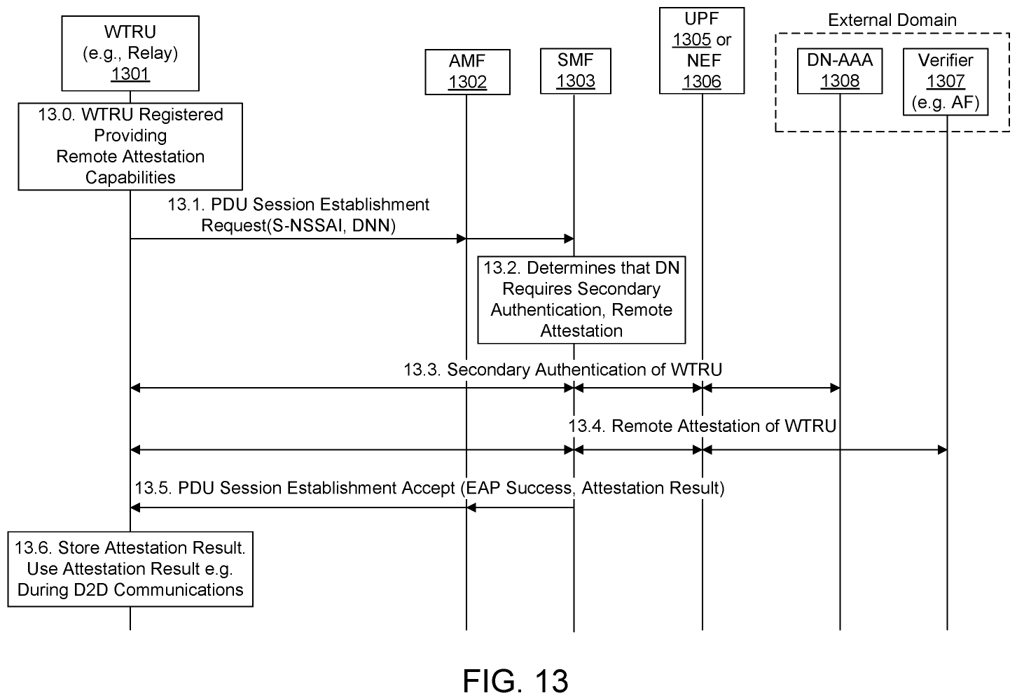

FIG. 13 illustrates an example method for WTRU remote attestation during PDU Session establishment, the method comprising any of the following actions:
13.0—The (e.g., relay) WTRU 1301 may be registered with the network. The (e.g., relay) WTRU 1301 may provide its remote attestation capabilities during the registration procedure.
13.1—The (e.g., relay) WTRU 1301 may send PDU Session Establishment request to access slice/DN where DN may require remote attestation. A first network node (e.g., AMF) 1302 may check that the (e.g., relay) WTRU 1301 may be authorized for DN access based on the (e.g., relay) WTRU 1301 remote attestation capabilities and/or DN use (e.g., need) for remote attestation based on subscription data.
13.2—A second network node (e.g., SMF) 1303 may determine that DN may use (e.g., require) remote attestation for WTRU (e.g., based on DN subscription data). The second network node (e.g., SMF) 1303 may determine that DN may use (e.g., need) secondary authentication of WTRU before access.
13.3—The second network node (e.g., SMF) 1303 may initiate secondary authentication of the (e.g., relay) WTRU 1301 by a data network authentication authorization accounting (DN-AAA) server 1308 if needed based on previous step determination. The second network node (e.g., SMF) 1303 may hold performing UPF 1305 configuration (N4 session modification), for example, until successful completion of the following remote attestation step.
13.4—The second network node (e.g., SMF) 1303 may initiate remote attestation of the (e.g., relay) WTRU 1301 by verifier function based on previous step determination. A verifier 1307 may be co-located with the DN-AAA server 1308. The second network node (e.g., SMF) 1303 may find verifier information (e.g., fully qualified domain name (FQDN)) based on nay of local configuration, subscription data, request from the (e.g., relay) WTRU 1301, a message from the DN-AAA 1308 server during the authentication procedure. The (e.g., relay) WTRU 1301 may perform remote attestation protocol with Verifier via SMF/UPF. The (e.g., relay) WTRU 1301 may exchange remote attestation messages (e.g., transparently to network) over NAS transport with the Verifier function (e.g., in NAS containers). According to embodiments (e.g., alternatively to using UPF), the second network node (e.g., SMF) 1303 may exchange remote attestation protocol messages via a NEF 1306. After the successful completion of the remote attestation procedure, the verifier function may send a final remote attestation result to the second network node (e.g., SMF) 1303. The second network node (e.g., SMF) 1303 may store the successful remote attestation result associated with DNN locally and/or in unified data management (UDM).
13.5—The second network node (e.g., SMF) 1303 may send the Remote attestation result to the (e.g., relay) WTRU 1301 in a PDU Session Establishment Accept message.
13.6—The (e.g., relay) WTRU 1301 stores the remote attestation result. The (e.g., relay) WTRU 1301 may provide the result for use during subsequent procedures (e.g., during D2D communications, as a relay as described above, e.g., path switch based on trustworthiness).

According to embodiments, the remote attestation procedure may be performed by the (e.g., relay) WTRU in response to receiving the PDU session establishment accept message which may include verifier information (e.g., FQDN) and remote attestation pending indication. The (e.g., relay) WTRU may perform the remote attestation with verifier over the user plane (UP) using the established PDU Session. The SMF may restrict traffic on the PDU Session (e.g., configure UPF accordingly) for the (e.g., relay) WTRU communication with the verifier (e.g., not allowing any other DN traffic). In case of (e.g., upon) successful completion of remote attestation, the verifier may inform SMF via NEF/PCF (e.g., using an API Nnef_AFSessionWithQoS) of a successful remote attestation. The SMF may update the UPF (e.g., N4 session modification) to allow traffic towards DN and/or may inform the WTRU of granted access to DN during a PDU session modification procedure.

### Assertion of WTRU Trustworthiness Based on Remote Attestation During Registration Procedure Using an Authentication/Attestation Server

According to embodiments, the WTRU trustworthiness may be established during a registration management procedure. An example may be that of a WTRU (e.g., Relay) that wishes to access or provide access to a sensitive resource (e.g., a sensitive network slice). An example may be that of a relay that may (e.g., need to) provide one or more highly sensitive relay services (e.g., used by government agencies) using such slices.

A WTRU remote attestation may be performed by an attestation server (e.g., co-located with a AAA server) as part of an enhanced Registration procedure with secondary authentication and/or attestation. The WTRU may perform remote attestation which may follow the authentication message exchange with the authentication server. The AMF may determine that (e.g., supplemental) Remote attestation may be used (e.g., required) based on WTRU subscription information. A Remote attestation procedure with the AAA server may be executed (e.g., using EAP or other transport) via AMF over NAS transport. The Remote attestation evidence/result (e.g., as a AAA signed token, signed by the verifier) may be provided by the AAA server via the network to WTRU (e.g., in a NAS message, WTRU Configuration Update procedure). Based on the AAA server's appraisal policy, the AAA may provide a positive or negative result to the network/WTRU, and the network (AMF) may decide to de-register the WTRU or provide access based on WTRU trustworthiness (e.g., authorize non-relay services, reject a request for PDU Session access on behalf of remote WTRU). The WTRU may use the attestation result in subsequent procedures for communicating with other WTRUs or a network entity.

According to embodiments, the remote attestation evidence may be used by the WTRU acting as a relay (or residential gateway or the like) as per the above embodiments (e.g., during relay discovery/selection or link establishment with relay). The remote WTRU may be configured with an RSC associated with an indication of assertion claims of trustworthiness requirements and use it as described above. The relay WTRU may be configured with an indication of assertion claims of trustworthiness requirements. Such indication may apply for one or more or any PLMN. Based on this indication the relay WTRU may be expected to obtain and present trustworthiness info evidence as per the above embodiment.

As in the above embodiment, the remote attestation server may be an NF in the MNO domain or operated by a 3rd party.

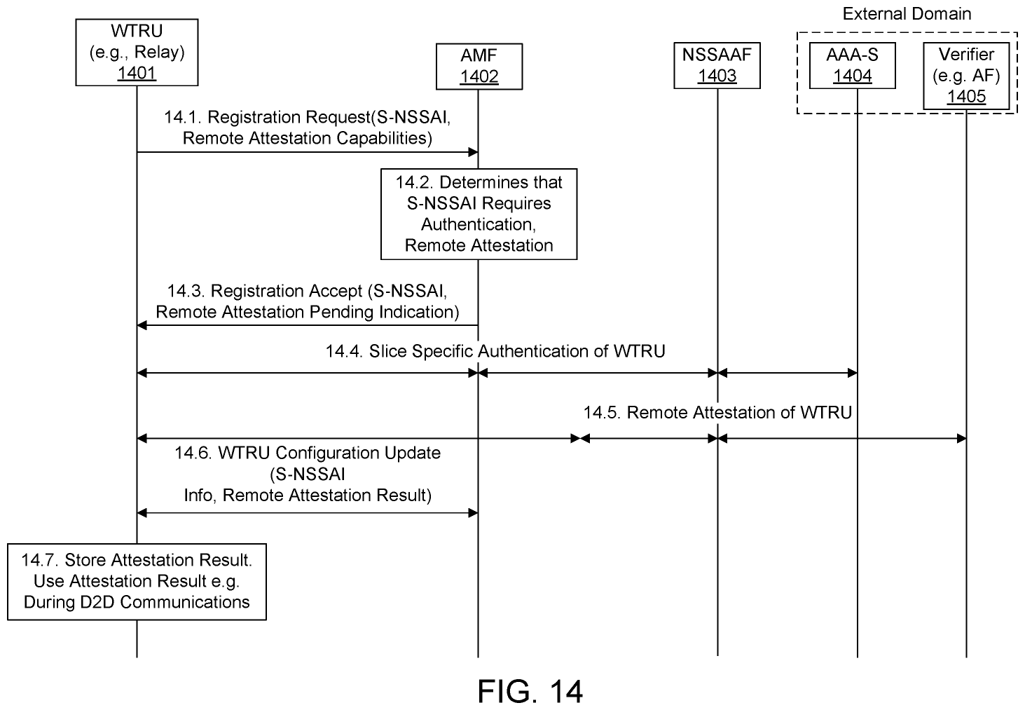

FIG. 14 illustrates an example method for WTRU remote attestation during a registration procedure, the method comprising any of the following actions:
14.1—The (e.g., relay) WTRU 1401 may send a registration request message that may include its remote attestation capabilities and/or S-NSSAI that may be subject to remote attestation.
14.2—The network node (e.g., AMF) 1402 may check that the (e.g., relay) WTRU 1401 may be authorized for S-NSSAI access. If the (e.g., relay) WTRU 1401 is remote attestation capable, the network node (e.g., AMF) 1402 may determine that S-NSSAI may be subject to remote attestation based on subscription information for that slice. The network node (e.g., AMF) 1402 may determine if remote attestation is to be performed based on any previous attestation result for that S-NSSAI and/or if remote attestation is ongoing.
14.3—The network node (e.g., AMF) 1402 may send a registration accept including a remote attestation pending indication.
14.4—The network node (e.g., AMF) 1402 may initiate a slice-specific authentication procedure (e.g., if the slice is subject to both authentication and remote attestation).
14.5—The (e.g., relay) WTRU 1401 may perform a remote attestation procedure with the verifier 1405 (e.g., using network control plane transport). The (e.g., relay) WTRU 1401 may exchange remote attestation messages with the Verifier function via the network node (e.g., AMF) 1402/NSSAAF 1403 (e.g., in NAS containers). The NSSAAF 1403 may route messages to the verifier 1405 (which may be co-located with AAA-S/AAA server 1404) based on S-NSSAI. In case of (e.g., after) the successful completion of the remote attestation procedure, the Verifier function may send a final remote attestation result to the network node (e.g., AMF) 1402.
14.6—Based on the result of the remote attestation procedure, the network node (e.g., AMF) 1402 may initiate a WTRU configuration update procedure to send the remote attestation result to the (e.g., relay) WTRU 1401.
14.7—The (e.g., relay) WTRU 1401 stores the Remote attestation result. The (e.g., relay) WTRU 1401 provides the result during subsequent procedures (e.g., during D2D communications, as a relay as described above).

### Trustworthiness Token

The Trustworthiness Token may be an electronic document used to prove the binding of the WTRU (e.g., Remote or Relay) identity with the verified evidence of trustworthiness. The token may include and be cryptographically bound to the information about the identity of the WTRU (e.g., Remote or Relay), the listed evidence submitted to and verified by the Verifier, and include the digital signature of an entity that has verified the evidence (e.g., Verifier AF). If the signature is valid, and the entity examining the token (e.g., Remote or relay WTRU) trusts the Verifier, then it can use that evidence to establish secure communication with the other entity (e.g., Remote or relay WTRU).

Since the entity that analyses the Trustworthiness Token may use the Public Key of the entity that has verified the evidence (e.g., Verifier AF) to examine the Trustworthiness Token, such examination may be achieved without an online check with the entity that has verified the evidence (e.g., Verifier AF).

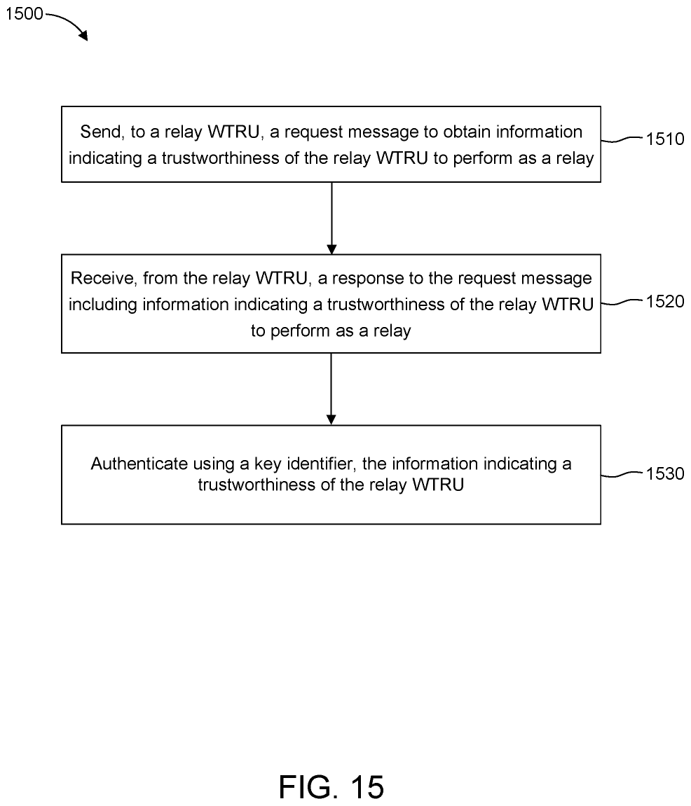

FIG. 15 illustrates an example of a method 1500 for assertion of a relay WTRU trustworthiness, implemented by a WTRU 102.

According to embodiments, the WTRU 102 may be configured to send, to a relay WTRU, a request message to obtain information indicating a trustworthiness of the relay WTRU to perform as a relay (1510).

According to embodiments, the WTRU 102 may be configured to receive, from the relay WTRU, a response to the request message including information indicating a trustworthiness of the relay WTRU to perform as a relay (1520).

According to embodiments, the WTRU 102 may be configured to authenticate using a key identifier, the information indicating a trustworthiness of the relay WTRU (1530).

According to embodiments, the WTRU 102 may be configured to establish a unicast link with the relay WTRU, on condition that the information indicating a trustworthiness of the relay WTRU is authenticated.

According to embodiments, the unicast link is a PC5 link.

According to embodiments, the WTRU 102 may be configured to obtain the key identifier from a network entity.

According to embodiments, the information indicating a trustworthiness of the relay WTRU is associated to a validity period.

According to embodiments, the WTRU 102 may be configured to send, to the relay WTRU, an acknowledgment message, on condition that the information indicating a trustworthiness of the relay WTRU is authenticated.

According to embodiments, the WTRU 102 may be configured to store the information indicating a trustworthiness of the relay WTRU.

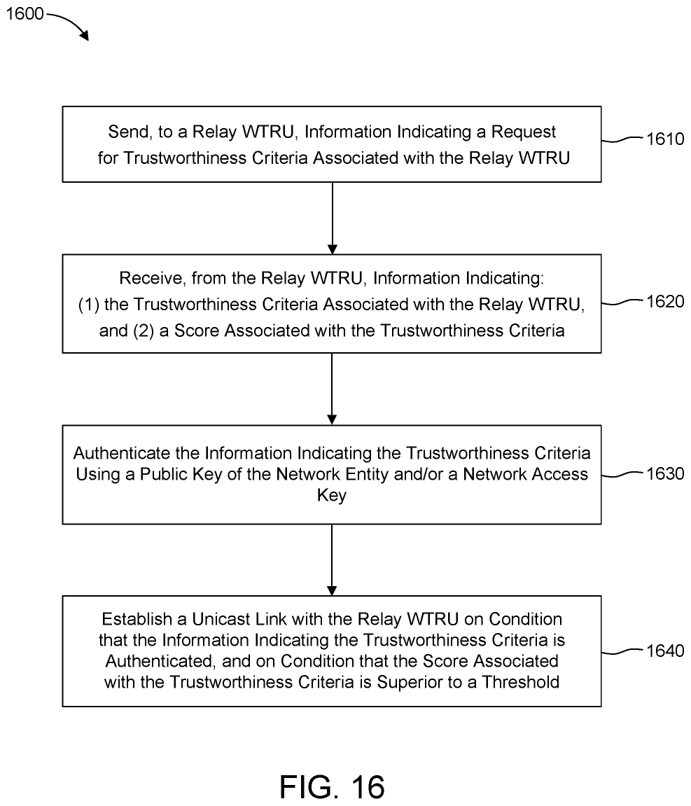

FIG. 16 illustrates another example of a method 1600 for assertion of a relay WTRU trustworthiness, implemented by a WTRU 102.

According to embodiments, the WTRU 102 may be configured to send, to a relay WTRU, information indicating a request for trustworthiness criteria associated with the relay WTRU (1610).

According to embodiments, the WTRU 102 may be configured to receive, from the relay WTRU, information indicating: (1) the trustworthiness criteria associated with the relay WTRU, and/or (2) a score associated with the trustworthiness criteria (1620).

According to embodiments, the WTRU 102 may be configured to authenticate the information indicating the trustworthiness criteria, for example, using a public key of the network entity and/or a network access key (1630).

According to embodiments, the WTRU 102 may be configured to establish a unicast link with the relay WTRU, for example, on condition that the information indicating the trustworthiness criteria is authenticated, and/or for example, on condition that the score associated with the trustworthiness criteria is superior to a threshold (1640).

According to embodiments, the WTRU 102 may be configured to obtain further information indicating: (1) the trustworthiness criteria associated with a further relay WTRU and (2) a score associated with the trustworthiness criteria associated with the further relay WTRU.

According to embodiments, the unicast link is established with the relay WTRU on condition that the score associated with the trustworthiness criteria of the relay WTRU is superior to the score associated with the trustworthiness criteria of the further relay WTRU.

According to embodiments, the further information is obtained from a storage unit of the remote WTRU.

According to embodiments, an integrity of the information indicating the trustworthiness criteria associated with the relay WTRU is protected by the network entity.

According to embodiments, the trustworthiness criteria of the relay WTRU is verified by a network entity.

According to embodiments, the unicast link is a PC5 link.

According to embodiments, the trustworthiness criteria is associated with a period of time during which the information indicating the trustworthiness criteria is valid.

According to embodiments, the trustworthiness criteria of the relay WTRU is associated with a resource being accessed by the relay WTRU.

According to embodiments, the WTRU 102 may be configured to store the information indicating the trustworthiness criteria of the relay WTRU.

According to embodiments, the WTRU 102 may be configured to send, to the relay WTRU, information indicating trustworthiness criteria of the remote WTRU, wherein the information is integrity protected by the network entity.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 1 6 or means-plus-function claim format, and any claim without the terms “means for” is not so intended.

1. A method implemented by a remote wireless transmit/receive unit (WTRU), the method comprising:
sending, to a relay WTRU, information indicating a request for trustworthiness criteria associated with the relay WTRU;
receiving, from the relay WTRU, information indicating: (1) the trustworthiness criteria associated with the relay WTRU, and (2) a score associated with the trustworthiness criteria;
authenticating the information indicating the trustworthiness criteria using a public key of one or more of a network entity and a network access key; and
establishing a unicast link with the relay WTRU on condition that the information indicating the trustworthiness criteria is authenticated, and on condition that the score associated with the trustworthiness criteria satisfies a threshold.

2. The method of claim 1, wherein the relay WTRU is a first relay WTRU, the trustworthiness criteria are first trustworthiness criteria, and the score is a first score, the method further comprising:
obtaining further information indicating: (1) second trustworthiness criteria associated with a second relay WTRU and (2) a second score associated with the second trustworthiness criteria; and
wherein the unicast link is established with the relay WTRU on condition that the first score is superior to the second score.

3. The method according to claim 2, wherein the further information is obtained from a storage unit of the remote WTRU.

4. The method according to claim 1, wherein an integrity of the information indicating the trustworthiness criteria is protected by the network entity.

5. The method according to claim 1, wherein the trustworthiness criteria are verified by the network entity.

6. The method according to claim 1, wherein the unicast link is a PC5 link.

7. The method according to claim 1, wherein the trustworthiness criteria are associated with a period of time during which the information indicating the trustworthiness criteria is valid.

8. The method according to claim 1, wherein the trustworthiness criteria are associated with a resource being accessed by the relay WTRU.

9. The method according to claim 1, further comprising storing the information indicating the trustworthiness criteria.

10. The method according to claim 1, wherein the trustworthiness criteria are first trustworthiness criteria, the method further comprising: sending, to the relay WTRU, second information indicating trustworthiness criteria of the remote WTRU, wherein the second information is integrity protected by the network entity.

11. A remote wireless transmit/receive unit (WTRU) comprising circuitry, including any of a transmitter, a receiver, a processor and memory, the WTRU configured to:
send, to a relay WTRU, information indicating a request for trustworthiness criteria associated with the relay WTRU;
receive, from the relay WTRU, information indicating: (1) the trustworthiness criteria associated with the relay WTRU, and (2) a score associated with the trustworthiness criteria;
authenticate the information indicating the trustworthiness criteria using a public key of one or more of a network entity and a network access key; and
establish a unicast link with the relay WTRU on condition that the information indicating the trustworthiness criteria is authenticated, and on condition that the score associated with the trustworthiness criteria satisfies a threshold.

12. The remote WTRU according to claim 11, wherein the relay WTRU is a first relay WTRU, the trustworthiness criteria are first trustworthiness criteria, and the score is a first score, and wherein the remote WTRU is configured to:
obtain further information indicating: (1) second trustworthiness criteria associated with a second relay WTRU and (2) a second score associated with the second trustworthiness criteria; and
wherein the unicast link is established with the relay WTRU on condition that the first score is superior to the second score.

13. The remote WTRU according to claim 12, wherein the further information is obtained from a storage unit of the remote WTRU.

14. The remote WTRU according to claim 11, wherein an integrity of the information indicating the trustworthiness criteria is protected by the network entity.

15. The remote WTRU according to claim 11, wherein the trustworthiness criteria are verified by the network entity.

16. The remote WTRU according to claim 11, wherein the unicast link is a PC5 link.

17. The remote WTRU according to claim 11, wherein the trustworthiness criteria are associated with a period of time during which the information indicating the trustworthiness criteria is valid.

18. The remote WTRU according to claim 11, wherein the trustworthiness criteria are associated with a resource being accessed by the relay WTRU.

19. The remote WTRU according to claim 11, configured to store the information indicating the trustworthiness criteria.

20. The remote WTRU according to claim 11, wherein the trustworthiness criteria are first trustworthiness criteria, and wherein the remote WTRU is configured to send, to the relay WTRU, second information indicating trustworthiness criteria of the remote WTRU, wherein the second information is integrity protected by the network entity.
